(19) United States
(12) Patent Application Publication
(10) Pub. No.: US 2020/0266406 A1
(43) Pub. Date: Aug. 20, 2020

(54) SEPARATORS, ELECTROCHEMICAL DEVICES COMPRISING THE SEPARATOR, AND METHODS FOR MAKING THE SEPARATOR

(71) Applicant: SHANGHAI ENERGY NEW MATERIALS TECHNOLOGY CO., LTD., Shanghai (CN)

(72) Inventors: Alex CHENG, Shanghai (CN); Yongle CHEN, Shanghai (CN); Jinzhen BAO, Shanghai (CN); Fangbo HE, Shanghai (CN); Weiqiang WANG, Shanghai (CN)

(21) Appl. No.: 16/754,934

(22) PCT Filed: Oct. 8, 2018
(86) PCT No.: PCT/CN2018/109307

§ 371 Date: Apr. 9, 2020

(30) Foreign Application Priority Data
Oct. 9, 2017 (CN) 201710931199.3

(51) Int. Cl. H01M 2/16; H01M 10/0525; H01M 2/14

(52) U.S. Cl. CPC H01M 2/166; H01M 2/145; H01M 10/0525

(57) ABSTRACT

Disclosed are a separator for an electrochemical device, comprising a porous base membrane and a coating layer being formed on at least one side of the porous base membrane, wherein the coating layer comprises polybenzimidazoles having a weight average molecular weight ranging from 5×10³ to 1×10⁶; as well as an electrochemical device including the separator and a method for making the separator.

### CROSS REFERENCE TO RELATED APPLICATION

The present application claims the benefit of priority to Chinese Application No. 201710931199.3, filed on Oct. 9, 2017, the content of which is incorporated by reference.

### TECHNICAL FIELD

The present disclosure relates to separators for electrochemical devices, electrochemical devices comprising the separator, and methods for making the separator.

### BACKGROUND

With the growing market of energy storage, batteries and other forms of electrochemical devices are given more and more attentions. For example, lithium secondary batteries have been extensively used as energy sources in, for example, mobile phones, laptops, power tools, electrical vehicles, etc.

An electrode assembly of an electrochemical device usually comprises a positive electrode, a negative electrode, and a permeable membrane (i.e., separator) interposed between the positive electrode and the negative electrode. The positive electrode and the negative electrode are prevented from being in direct contact with each other by the separator, thereby avoiding internal short circuit. In the meanwhile, ionic charge carriers (e.g., lithium ions) are allowed to pass the separator through channels within the separator so as to close the current circuit. Separator is a critical component in an electrochemical device because its structure and properties can considerably affect the performances of the electrochemical device, including, for example, internal resistance, energy density, power density, cycle life, and safety.

A separator is generally formed by a polymeric microporous membrane. For example, polyolefin-based microporous membrane has been widely used as separators in lithium secondary batteries because of its favorable chemical stability and excellent physical properties. However, they have poor thermal stability as polyolefin usually has a low melting point, such as lower than 170° C. When the temperature inside of the electrochemical device rises, the polyolefin-based microporous membrane may shrink or melt, resulting in a volume change, which may lead to a direct contact of the positive electrode and the negative electrode, i.e., internal short circuit. The internal short circuit can cause some accidents such as battery bulge, burning, explosion, etc. Some electrochemical devices (e.g., automotive batteries for electric vehicles) that may be used in an environment with a high temperature require separators have certain high heat-resistance. The polyolefin-based microporous membrane may not meet such heat-resistance requirements.

To ensure the safety of electrochemical devices working in an environment with a high temperature, there is a need to develop separators of high heat-resistance.

### SUMMARY OF THE INVENTION

The present disclosure provides a separator for an electrochemical device, comprising a porous base membrane and a coating layer being formed on at least one side of the porous base membrane, wherein the coating layer comprises polybenzimidazoles (PBI) having a weight average molecular weight (M_{w}) ranging, for example, from 5×10³ to 1×10⁶.

The present disclosure also provides an electrochemical device comprising a positive electrode, a negative electrode, and the separator disclosed herein, interposed between the positive electrode and the negative electrode.

The present disclosure further provides a method for making the separator disclosed herein, comprising: preparing a coating slurry comprising PBI having a M_{w} ranging from 5×10³ to 1×10⁶ and at least one solvent; applying the coating slurry on at least one side of a porous base membrane to form a wet coating layer; and removing the at least one solvent from the wet coating layer.

### DETAILED DESCRIPTION

The present disclosure provides some exemplary embodiments of separators for electrochemical devices. In one embodiment of the present disclosure, a coating layer comprising PBI is formed on at least one side of a porous base membrane. PBI are known in the art and are a class of heterocyclic thermoplastics with high heat-resistance and chemical-resistance. See e.g., Polybenzimidazoles, New Thermally Stable Polymers, H. Vogel and C. S. Marvel, Journal of Polymer Science, Vol. L, pp. 511-539 (1961). They are usually prepared from an aromatic tetraamine and an aromatic/aliphatic dicarboxylic acid or a derivative of them. PBI may have, for example, a high glass transition temperature of about 350° C. or above. Because of PBI's outstanding heat-resistance, the coating layer containing PBI disclosed herein may show desired thermal stability. And the separator disclosed herein may have a low thermal shrinkage percentage in an environment with a high temperature, for example, at a temperature of 150° C. or above. The PBI disclosed herein may have an M_{w} ranging, for example, from 5×10³ to 1×10⁶, such as from 2×10⁴ to 2×10⁵. The density of the PBI disclosed herein may range, for example, from 1.2 to 1.4 g/cm³, such as from 1.3 to 1.4 g/cm³. The glass transition temperature of the PBI disclosed herein may range, for example, from 250° C. to 550° C., such as from 375° C. to 500° C. The PBI disclosed herein are shown in, for example, Progress in Synthesis, Properties, and Application in Fuel Cells of Polybenzimidazole, P U Hong-Ting and Y E Sheng, Polymer Bulletin, 2006 (2): 9-17. In one embodiment, the PBI disclosed herein is poly(2,2′-(m-phenylene)-5,5′-bibenzimidazole) having a repeating unit shown below:

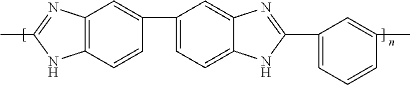

The “at least one side” disclosed herein means the coating layer containing PBI is disposed on one side or both sides of the porous base membrane, and the coating layer can be in direct contact or indirectly contact with the porous base membrane. The separator disclosed herein may have a laminated structure.

In some embodiments of the present disclosure, the coating layer is in direct contact with the porous base membrane, i.e., the coating layer is formed on at least one surface of the porous base membrane. In such a case, the separator disclosed herein may have a two-layer structure when only one surface of the porous base membrane is coated with the coating layer. The separator may have a three-layer structure when both surfaces of the porous base membrane are coated with the coating layer.

In some other embodiments, the coating layer indirectly contacts with the porous base membrane, i.e., the separator disclosed herein further comprises at least one additional layer (e.g., an adhesive layer) interposed between the coating layer and the porous base membrane.

In yet another embodiment, the separator disclosed herein may further comprise at least one additional layer (e.g., an adhesive layer) disposed on the outer surface of the coating layer.

The porous base membrane serves as a substrate and the coating layer is formed on at least one side thereof. The porous base membrane has a porous structure allowing gas, liquid, or ions to pass from one surface side to the other surface side thereof. The porous base membrane disclosed herein may have a thickness ranging, for example, from 10 to 20 μm, such as from 12 to 16 μm.

In some embodiments of the present disclosure, the porous base membrane disclosed herein is a polymeric microporous membrane prepared by, for example, a melting-extruding-stretching process, or a thermally induced phase separation (TIPS) process. The micropores within the polymeric microporous membrane may have an average pore size ranging, for example, from 10 to 300 nm, such as from 10 to 100 nm. The porosity of the polymeric microporous membrane may range, for example, from 20% to 70%, such as from 30% to 60%. Furthermore, the polymeric microporous membrane may have an air permeability ranging, for example, from 50 to 800 sec/100 ml, such as from 80 to 300 sec/100 ml. The polymeric microporous membrane may comprise at least one organic material chosen, for example, from vinyl polymer or copolymer, polyamide, polyimide, polyester, polysulfone, cellulose, and cellulose derivatives. The vinyl polymer or copolymer disclosed herein may be chosen, for example, from polyolefin (e.g., polyethylene (PE) and polypropylene (PP)), and polyvinyl acetate (PVAc). In some embodiments, the polymeric microporous membrane further comprises at least one inorganic material chosen, for example, from alumina, boehmite, silica, titanium oxide, cerium oxide, calcium oxide, zinc oxide, magnesium oxide, lithium nitride, calcium carbonate, barium sulfate, lithium phosphate, lithium titanium phosphate, lithium aluminum titanium phosphate, cerium titanate, calcium titanate, barium titanate, and lithium lanthanum titanate. The presence of the at least one inorganic material can increase the heat-resistance of the polymeric microporous membrane. The polymeric microporous membrane disclosed herein can be single-layered or multi-layered. An example of the multi-layered porous base membrane is PP/PE/PP three-layered porous membrane.

In some embodiments, a non-woven membrane may be used as the porous base membrane. The term “non-woven membrane” means a flat sheet including a multitude of randomly distributed fibers that form a web structure therein. The fibers generally can be bonded to each other or can be unbonded. The fibers can be staple fibers (i.e., discontinuous fibers of no longer than 10 cm in length) or continuous fibers. The fibers can comprise a single material or a multitude of materials, either as a combination of different fibers or as a combination of similar fibers each comprised of different materials. Examples of the non-woven membrane disclosed herein may exhibit dimensional stability, i.e., thermal shrinkage of less than 5% when heated to 100° C. for about two hours. The non-woven membrane may have a relatively large average pore size ranging, for example, from 0.1 to 20 μm, such as from 1 to 5 μm. The non-woven membrane may have a porosity ranging, for example, from 40% to 80%, such as from 50% to 70%. Furthermore, the non-woven membrane may have an air permeability of, for example, less than 500 sec/100 ml, such as ranging from 0 to 400 sec/100 ml, and further such as ranging from 0 to 200 sec/100 ml. The non-woven membrane disclosed herein may be formed of one chosen, for example, from PE, high density polyethylene (HDPE), PP, polybutylene, polypentene, polymethylpentene (TPX), polyethylene terephthalate (PET), polyamide, polyimide (PI), polyacrylonitrile (PAN), polytetrafluoroethylene (PTFE), polyester, polyacetal, polycarbonate, polyetherketone (PEK), polyetheretherketone (PEEK), polybutylene terephthalate (PBT), polyethersulfone (PES), polyphenylene oxide (PPO), polyphenylene sulfide (PPS), polyethylene naphthalene (PEN), cellulose fiber, viscose fiber, copolymers thereof, and mixtures thereof. In an example, a non-woven membrane formed of PET is used as the porous base membrane. The non-woven porous membrane disclosed herein can be prepared according to a method known in the art, such as electro-blowing, electro-spinning, or melt-blowing, or can be purchased directly in the market.

The coating layer disclosed herein is disposed on one side or both sides of the porous base membrane. The coating layer disclosed herein also has a porous structure allowing gas, liquid, or ions to pass from one surface side to the other surface side thereof. The pores within the coating layer may have an average pore size ranging, for example, from 10 to 500 nm, such as from 20 to 300 nm. The coating layer may have a porosity ranging, for example, from 20% to 70%, such as from 30% to 50%. Additionally, the coating layer on one side of the porous base membrane may have a thickness ranging, for example, from 0.5 to 4 μm, such as from 1.5 to 3 μm. In some embodiments, the coating layer may be formed by applying a coating slurry onto the porous base membrane through various suitable techniques, such as a roller coating, a spray coating, a dip coating, or a spin coating process.

In some embodiments, the coating layer disclosed herein comprises PBI and at least one inorganic filler. The at least one inorganic filler present in the coating layer can also help enhance the heat-resistance of the separator disclosed herein, thereby further preventing short circuit and improving dimensional stability of an electrochemical device employing the separator in an environment with a high temperature. In addition, the presence of the at least one inorganic filler may also facilitate, for example, the formation of pores in the coating layer, the increase of the physical strength of the coating layer, and/or the increase in an impregnation rate of a liquid electrolyte. The at least one inorganic filler may be fixed in the coating layer by the PBI. Various inorganic particles can be used as the at least one inorganic filler, including, for example, oxides, hydroxides, sulfides, nitrides, carbides, carbonates, sulfates, phosphates, titanates, and the like of at least one of metallic and semiconductor elements, such as Si, Al, Ca, Ti, B, Sn, Mg, Li, Co, Ni, Sr, Ce, Zr, Y, Pb, Zn, Ba, and La. For example, alumina (Al₂O₃), boehmite (γ-AlOOH), silica (SiO₂), titanium oxide (TiO₂), cerium oxide (CeO₂), calcium oxide (CaO), zinc oxide (ZnO), magnesium oxide (MgO), lithium nitride (Li₃N), calcium carbonate (CaCO₃), barium sulfate (BaSO₄), lithium phosphate (Li₃PO₄), lithium titanium phosphate (LTPO), lithium aluminum titanium phosphate (LATP), cerium titanate (CeTiO₃), calcium titanate (CaTiO₃), barium titanate (BaTiO₃) and lithium lanthanum titanate (LLTO) can be used as the at least one inorganic filler. The inorganic filler disclosed herein may have an average particle size ranging, for example, from 0.01 to 1 μm, such as from 0.02 to 0.5 μm.

To balance different characteristics (e.g., porosity, air permeability and weight) of the separator disclosed herein, the weight ratio of the PBI and the at least one inorganic filler present in the coating layer may be controlled in a specific range. In some embodiments, the coating layer comprises from 2 to 5 parts by weight of PBI and from 1 to 3 parts by weight of the at least one inorganic filler. In an example, the coating layer comprises from 3 to 4.8 parts by weight of PBI and from 1.2 to 2.8 parts by weight of the at least one inorganic filler.

The separator of the present disclosure can have improved heat-resistance as PBIs are included in the coating layer of the separator. In some embodiments, after a heat treatment of 150° C. for one hour, the separator of the present disclosure may have a thermal shrinkage percentage of, for example, less than 6%, such as less than 3%, and further such as less than 2%, either in a machine direction (MD) or in a transverse direction (TD). The low thermal shrinkage percentage indicates the separator of the present disclosure has excellent thermal stability.

The separator disclosed herein can have a wide range of applications and can be used for making high-energy density and/or high-power density batteries in many stationary and portable devices, e.g., automotive batteries, batteries for medical devices, and batteries for other large devices.

Further, the present disclosure provides an electrochemical device, comprising: a positive electrode, a negative electrode, and a separator disclosed herein, which is interposed between the positive electrode and the negative electrode. An electrolyte may be further included in the electrochemical device of the present disclosure. The separator is sandwiched between the positive electrode and the negative electrode to prevent physical contact between the two electrodes and the occurrence of a short circuit. The porous structure of the separator ensures a passage of ionic charge carriers (e.g., lithium ions) between the positive electrode and the negative electrode. In addition, the separator may also provide a mechanical support to the electrochemical device. The electrochemical devices disclosed herein include any devices in which electrochemical reactions occur. For example, the electrochemical devices may be at least one of electrolytic cells, primary batteries, secondary batteries, fuel cells, solar cells and capacitors. In some embodiments, the electrochemical device disclosed herein is a lithium secondary battery, such as a lithium ion secondary battery, a lithium polymer secondary battery, a lithium metal secondary battery, a lithium air secondary battery or a lithium sulfur secondary battery.

With the separator of the present disclosure inside, the electrochemical device disclosed herein can exhibit improved safety in an environment with a high temperature as discussed above.

The electrochemical device disclosed herein may be manufactured by a conventional method known to one skilled in the art. In one embodiment, an electrode assembly is formed by placing a separator of the present disclosure between a positive electrode and a negative electrode, and an electrolyte is injected into the electrode assembly. The electrode assembly may be formed by a conventional process, such as a winding process or a lamination (stacking) and folding process.

Further disclosed herein are embodiments of a method for making the separator of the present disclosure. In some embodiments, the method is a wet coating process. For example, the method may comprise:
(A) preparing a coating slurry comprising PBI and at least one solvent;
(B) applying the coating slurry on at least one side of a porous base membrane to form a wet coating layer; and
(C) removing the at least one solvent from the wet coating layer.

In the step (A), the coating slurry is prepared by dissolving PBI into the at least one solvent. The M_{w} of PBI used herein may range, for example, from 5×10³ to 1×10⁶. The M_{w} of PBI can be measured using a method known in the art, such as viscometry. The PBI used herein may, for example, be in a form of power. The coating slurry may comprise, for example, from 2 to 5 parts by weight of the PBI and from 80 to 90 parts by weight of the at least one solvent.

The solubility of the PBI in the at least one solvent depends on the type of solvent used in the step (A). Therefore, the selection of the at least one solvent may depend on the type of PBI used to form the coating slurry. For example, the at least one solvent may have a solubility parameter similar to that of the PBI to be dissolved, and a low boiling point, because such solvent can facilitate uniform mixing and coating process and needs to be removed in the following operation. The at least one solvent may, for example, be a polar solvent. The at least one solvent that may be used herein is chosen, for example, from dimethylacetamide (DMAC), N-methyl pyrrolidone (NMP), N,N-dimethylformamide (DMF), dimethyl sulfoxide (DMSO), and acetone. In some embodiments, the PBI firstly swell and then are dissolved in the at least one solvent. To help the PBI dissolve in the at least one solvent quickly, various methods can be used. For example, the temperature of the at least one solvent may be controlled in a range of, for example, from 60° C. to 100° C., such as from 50° C. to 80° C. In addition, the coating slurry may further comprise at least one solubilizer to increase the solubility of the PBI. The at least one solubilizer may be chosen, for example, from lithium chloride (LiCl), calcium chloride (CaCl₂), and dodecylbenzene sulfonic acid.

In some embodiments, the coating slurry prepared in the step (A) may further comprise at least one inorganic filler. Thus the coating slurry may be a suspension as the at least one inorganic filler disperses in the coating slurry. As discussed above, various inorganic particles can be used as the at least one inorganic filler, including, for example, oxides, hydroxides, sulfides, nitrides, carbides, carbonates, sulfates, phosphates, titanates, and the like of at least one of metallic and semiconductor elements, such as Si, Al, Ca, Ti, B, Sn, Mg, Li, Co, Ni, Sr, Ce, Zr, Y, Pb, Zn, Ba, and La. To help the at least one inorganic filler well disperse in the coating slurry and avoid agglomeration, the coating slurry may further comprise at least one dispersant. Polyethylene oxide (PEO) in the form of powder may be used herein as a suitable dispersant. The M_{w} of the PEO used herein may range, for example, from 1×10⁵ to 1×10⁶, such as from 2×10⁵ to 5×10⁵. For example, ultrafine powder of PEO having an M_{w} of 3×10⁵ can be used as the at least one dispersant.

In one embodiment, the coating slurry comprises from 2 to 5 parts by weight of the PBI, from 1 to 3 parts by weight of the at least one inorganic filler, and from 80 to 90 parts by weight of the at least one solvent.

In another embodiment, the coating slurry comprises from 2 to 5 parts by weight of the PBI, from 1 to 3 parts by weight of the at least one inorganic filler, from 3 to 8 parts by weight of the at least one solubilizer, and from 80 to 90 parts by weight of the at least one solvent.

In some embodiments, the coating slurry may be prepared by mixing the PBI, the at least one solvent, and optionally at least one another component, such as the at least one inorganic filler, the at least one solubilizer, or the at least one dispersant. The mixing may be processed during stirring. In some other embodiments, the coating slurry may be prepared by the following steps:
(A1) adding the PBI into a first solvent to obtain a first slurry;
(A2) adding the at least one inorganic filler into a second solvent to obtain a second slurry; and
(A3) mixing the first slurry and the second slurry to obtain the coating slurry.

Each of the first solvent and the second solvent may be chosen, for example, from DMAC, NMP, DMF, DMSO, acetone, and a mixture thereof. The compositions of the first solvent and the second solvent may be the same or different.

In the step (A1), the at least one solubilizer as described above may be added into the first solvent to increase the solubility of the PBI. The weight ratio of the at least one solubilizer and the first solvent may range, for example, from 1.5:1 to 2:1.

In the step (A1), the PBI and the first solvent may be mixed through various methods, including, for example, mechanical stirring, kneading, ball-milling, and ultrasonic dispersion.

In the step (A2), the at least one dispersant as described above may be added into the second solvent to help the at least one inorganic filler disperse in the second slurry.

In the step (B), the coating slurry prepared in the step (A) is applied on at least one side of the porous base membrane. Any coating method known in the art may be used to coat the porous base membrane with the coating slurry, such as roller coating, spray coating, dip coating, spin coating, and combinations thereof. Examples of the roller coating may include gravure coating, silk screen coating, and slot die coating. The coating speed may be controlled in a range of, for example, from 1 to 30 m/min, such as from 5 to 15 m/min. In the case that both sides of the porous base membrane are coated with the coating slurry, the both sides can be coated simultaneously or by sequence.

In the step (C), the at least one solvent can be removed from the wet coating layer through a method known in the art, such as a thermal evaporation, a vacuum evaporation, a phase inversion process, or a combination thereof. When the at least one solvent is removed, a coating layer having a porous structure can be formed.

In some embodiments, the at least one solvent may be removed through a combination of thermal evaporation and vacuum evaporation. For example, the porous base membrane coated with the coating slurry may be subjected to a vacuum oven for a predetermined time period so as to remove the at least one solvent from the wet coating layer. The pressure and the temperature of the vacuum oven may depend on the amount and type of solvent to be removed.

Phase inversion process is an alternative method to remove the at least one solvent, which may be initiated by exposing the wet coating layer to a poor solvent of PBI, such as water, alcohols (e.g., ethanol), or a combination thereof. The water used herein is, for example, deionized water. When the wet coating layer is exposed to the poor solvent, most of the at least one solvent may transfer from the coating layer to the poor solvent, resulting in a porous structure in the coating layer. The phase inversion process is energy-efficient as no phase change happens when the at least one solvent is removed. In some embodiments, the step (C) may comprise immersing the coated porous base membrane in a poor solvent for a predetermined time period, for example, from 0.5 to 3 minutes, such as from 1 to 2 minutes. To remove the at least one solvent from the wet coating layer more efficiently, a flowing poor solvent may be used, or passing the coated porous base membrane through a tank of poor solvent at a predetermined speed. The step (C) may further comprise taking the coated porous base membrane out from the poor solvent and drying the coated porous base membrane to remove a residue of the at least one solvent and/or the poor solvent. The residue of the at least one solvent and/or the poor solvent may be removed by, for example, thermal evaporation, vacuum evaporation or a combination thereof.

The thermal evaporation disclosed herein may be carried out in a closed oven or an open oven. For example, passing the coated porous base membrane through a multi-stage open oven, e.g., a three-stage oven, at a predetermined speed. The three-stage oven may have a temperature ranging, for example, from 45 to 55° C. in its first stage, a temperature ranging, for example, from 55 to 65° C. in its second stage, and a temperature ranging, for example, from 50 to 60° C. in its third stage. In an example, the three-stage oven has temperatures of 50° C., 60° C., and 55° C. in its first, second, and third stages, respectively.

Through the method set forth above, a dry and porous coating layer containing PBI may be formed on at least one side of the porous base membrane. The coating layer may also comprise inorganic fillers that are embedded in the coating layer by PBI. Due to the high thermal and chemical stabilities of PBI, the separator can show improved heat-resistance. The electrochemical devices employing the separators disclosed herein may have improved safety.

Reference is now made in detail to the following examples that relate to preparation of the separators according to the present disclosure. It is to be understood that the following examples are illustrative only and the present disclosure is not limited thereto.

Poly(2,2′-(m-phenylene)-5,5′-bibenzimidazole) having an M_{w} ranging from 2×10⁴ to 2×10⁵, a density ranging from 1.3 to 1.4 g/cm³, a glass transition temperature ranging from 350° C. to 500° C., and in a form of powder was used as PBI in Examples 1-4. A PE membrane having a thickness of 12 μm was used as the porous base membrane in Examples 1-4.

### Example 1

0.4 kg LiCl was added into 4.2 kg NMP to obtain a first slurry. 0.25 kg PBI powder was slowly added into the first slurry to obtain a second slurry. The second slurry was placed in a water bath of 60° C. and stirred until all PBI power was dissolved. 0.1 kg Alumina was added into 3.25 kg NMP to obtain a third slurry. The second slurry was mixed with the third slurry to obtain a coating slurry.

The above prepared coating slurry was coated on one surface of a porous base membrane through a gravure coating process with a speed of 12 m/min to form a wet coating layer. The coated membrane was immersed in water for 1 minute. After taken out from water, the coated membrane was passed through a three-stage oven, each stage of which had a temperature of 50° C., 60° C., and 55° C., respectively. And a separator having a thickness of 14 μm was thus obtained.

### Example 2

0.75 kg CaCl₂) was added into 7.5 kg DMAC to obtain a first slurry. 0.5 kg PBI powder was slowly added into the first slurry to obtain a second slurry. The second slurry was placed in a water bath of 60° C. and stirred until all PBI power was dissolved. 0.3 kg Alumina was added into 1.5 kg DMAC to obtain a third slurry. The second slurry was mixed with the third slurry to obtain a coating slurry.

The above prepared coating slurry was coated on one surface of a porous base membrane through a gravure coating process with a speed of 12 m/min to form a wet coating layer. The coated membrane was immersed in water for 1 minute. After taken out from water, the coated membrane was passed through a three-stage oven, each stage of which had a temperature of 50° C., 60° C., and 55° C., respectively. And a separator having a thickness of 14 μm was thus obtained.

### Example 3

0.45 kg Dodecylbenzene sulfonic acid was added into 6 kg NMP to obtain a first slurry. 0.3 kg PBI powder was slowly added into the first slurry to obtain a second slurry. The second slurry was placed in a water bath of 60° C. and stirred until all PBI power was dissolved. 0.2 kg Boehmite was added into 3 kg DMF to obtain a third slurry. The second slurry was mixed with the third slurry to obtain a coating slurry.

The above prepared coating slurry was coated on both surfaces of a porous base membrane through a gravure coating process with a speed of 12 m/min to form a wet coating layer. The coated membrane was immersed in water for 1.5 minutes. After taken out from water, the coated membrane was passed through a three-stage oven, each stage of which had a temperature of 50° C., 60° C., and 55° C., respectively. And a separator having a thickness of 16 μm was thus obtained.

### Example 4

0.75 kg CaCl₂) was added into 6 kg DMAC to obtain a first slurry. 0.5 kg PBI powder was slowly added into the first slurry to obtain a second slurry. The second slurry was placed in a water bath of 60° C. and stirred until all PBI power was dissolved. 0.2 kg magnesium oxide was added into 2.5 kg NMP to obtain a third slurry. The second slurry was mixed with the third slurry to obtain a coating slurry.

The above prepared coating slurry was coated on both surfaces of a porous base membrane through a gravure coating process with a speed of 12 m/min to form a wet coating layer. The coated membrane was immersed in water for 1.5 minutes. After taken out from water, the coated membrane was passed through a three-stage oven, each stage of which had a temperature of 50° C., 60° C., and 55° C., respectively. And a separator having a thickness of 16 μm was thus obtained.

### Comparative Example

0.6 kg polyvinylidene fluoride (PVDF) was added into 7 kg DMAC. The mixture of PVDF and DMAC was stirred for 1 to 2 hours to obtain a coating slurry. The same procedures as set forth above in Example 1 were used to prepare a separator using the above prepared coating slurry.

Air Permeability Test

For each separator, its air permeability was tested using an air permeability tester (Asahi-Seiko EGO1-55-1MR) according to a method set forth in Japanese Standard “JIS P8117-2009 Paper and Board-Determination of Air Permeance.”

Thermal Shrinkage Test

For each separator, the thermal shrinkage percentage was measured as follows: a separator sample of 100 mm (MD)×100 mm (TD) was prepared. A square of 80 mm (MD)×80 mm (TD) was marked on the separator sample. The separator sample was placed in an oven of 150° C. for one hour and then taken out from the oven for cooling down. The MD and TD length of the marked square were measured and recorded as L_{MD} (mm) and L_{TD} (mm), respectively. The thermal shrinkage percentage was calculated according to the following formula:

$$\text{Thermal Shrinkage} ( \% ) = \frac{80 \times 80 - {L}_{M D} {L}_{T D}}{80 \times 80} \times 100 \%$$

Table 1 summarizes the test results of the separators that were prepared according to Examples 1 to 4 and Comparative Example.

TABLE 1

| | | Thermal Shrinkage |
|---|---|---|
| | Air Permeability | Percentage at |
| | (s/100 cc) | 150° C., 1 h (%) |
| Example 1 | 276 | 2.6 |
| Example 2 | 272 | 2.5 |
| Example 3 | 296 | 1.5 |
| Example 4 | 292 | 1.9 |
| Comparative Example | 342 | 30.6 |

The air permeability results in Table 1 show that the air permeability values of the separators prepared in Examples 1-4 using the method of the present disclosure were lower than that of the PVDF-coated separator in Comparative Example, indicating separators prepared in Examples 1-4 had better air permeability properties.

The thermal shrinkage results in Table 1 show that after the heat treatment at 150°, serious thermal shrinkage happened to the PVDF-coated separator in Comparative Example. However, the separators prepared in Examples 1-4 using the method of the present disclosure had lower thermal shrinkage percentages than the PVDF-coated separator in Comparative Example, indicating they had improved heat-resistance.

What is claimed is:

1. A separator for an electrochemical device, comprising:
a porous base membrane; and
a coating layer being formed on at least one side of the porous base membrane,
wherein the coating layer comprises polybenzimidazoles having a weight average molecular weight ranging from 5×10³ to 1×10⁶.

2. The separator according to claim 1, wherein the coating layer comprises from 2 to 5 parts by weight of polybenzimidazoles and from 1 to 3 parts by weight of at least one inorganic filler.

3. The separator according to claim 2, wherein the at least one inorganic filler is chosen from oxides, hydroxides, sulfides, nitrides, carbides, carbonates, sulfates, phosphates, and titanates comprising at least one of metallic and semiconductor elements.

4. The separator according to claim 3, wherein the at least one of metallic and semiconductor elements is chosen from Si, Al, Ca, Ti, B, Sn, Mg, Li, Co, Ni, Sr, Ce, Zr, Y, Pb, Zn, Ba, and La.

5. The separator according to claim 2, wherein the at least one inorganic filler is chosen from alumina, boehmite, silica, titanium oxide, cerium oxide, calcium oxide, zinc oxide, magnesium oxide, lithium nitride, calcium carbonate, barium sulfate, lithium phosphate, lithium titanium phosphate, lithium aluminum titanium phosphate, cerium titanate, calcium titanate, barium titanate, and lithium lanthanum titanate.

6. The separator according to claim 1, wherein the coating layer on one side of the porous base membrane has a thickness ranging from 0.5 to 4 μm.

7. The separator according to claim 1, wherein the porous base membrane comprises at least one organic material chosen from vinyl polymer or copolymer, polyamide, polyimide, polyester, polysulfone, cellulose, and cellulose derivatives.

8. The separator according to claim 7, wherein the porous base membrane further comprises at least one inorganic material chosen from alumina, boehmite, silica, titanium oxide, cerium oxide, calcium oxide, zinc oxide, magnesium oxide, lithium nitride, calcium carbonate, barium sulfate, lithium phosphate, lithium titanium phosphate, lithium aluminum titanium phosphate, cerium titanate, calcium titanate, barium titanate, and lithium lanthanum titanate.

9. An electrochemical device comprising a positive electrode, a negative electrode, and a separator according to claim 1 interposed between the positive electrode and the negative electrode.

10. A method for making a separator, comprising:
preparing a coating slurry comprising polybenzimidazoles having a weight average molecular weight ranging from 5×10³ to 1×10⁶ and at least one solvent;
applying the coating slurry on at least one side of a porous base membrane to form a wet coating layer; and
removing the at least one solvent from the wet coating layer.

11. The method according to claim 10, wherein the coating slurry further comprises at least one inorganic filler.

12. The method according to claim 11, wherein the coating slurry is prepared by:
adding the polybenzimidazoles into a first solvent to obtain a first slurry;
adding the at least one inorganic filler into a second solvent to obtain a second slurry; and
mixing the first slurry and the second slurry to obtain the coating slurry.

13. The method according to claim 10, wherein during the preparation of the coating slurry, the polybenzimidazoles are dissolved in the at least one solvent at a temperature ranging from 60° C. to 100° C.

14. The method according to claim 10, wherein the at least one solvent is removed by:
immersing the coated porous base membrane in a poor solvent of polybenzimidazoles; and
drying the coated porous base membrane taken out from the poor solvent.

15. The method according to claim 14, wherein the drying comprises a three-stage heating process having a temperature ranging from 45 to 55° C. in the first stage, a temperature ranging from 55 to 65° C. in the second stage, and a temperature ranging from 50 to 60° C. in the third stage.

16. The method according to claim 10, wherein the at least one solvent is chosen from N-methyl pyrrolidone, dimethylacetamide, N,N-dimethylformamide, dimethyl sulfoxide, and acetone.

17. The method according to claim 11, wherein the coating slurry comprises:
from 2 to 5 parts by weight of the polybenzimidazoles;
from 1 to 3 parts by weight of the at least one inorganic filler; and
from 80 to 90 parts by weight of the at least one solvent.

18. The method according to claim 11, wherein the coating slurry further comprises at least one solubilizer.

19. The method according to claim 18, wherein the at least one solubilizer is chosen from lithium chloride, calcium chloride, and dodecylbenzene sulfonic acid.

20. The method according to claim 18, wherein the coating slurry comprises:
from 2 to 5 parts by weight of the polybenzimidazoles;
from 1 to 3 parts by weight of the at least one inorganic filler;
from 3 to 8 parts by weight of the at least one solubilizer; and
from 80 to 90 parts by weight of the at least one solvent.
